(19) United States
(12) Patent Application Publication
(10) Pub. No.: US 2011/0289450 A1
(43) Pub. Date: Nov. 24, 2011

(54) METHOD AND APPARATUS FOR DISPLAYING BATCH EXECUTION DATA OF AN INDUSTRIAL PLANT

(75) Inventors: Hirofumi Takahashi, Singapore (SG); Mitsuhiro Yamamoto, Tokyo (JP)

(73) Assignee: YOKOGAWA ELECTRIC CORPORATION, Tokyo (JP)

(21) Appl. No.: 12/785,022

(22) Filed: May 21, 2010

(51) Int. Cl. G06F 3/048

(52) U.S. Cl. 715/786; 715/791

(57) ABSTRACT

A method and apparatus for displaying batch execution data of an industrial plant configured for performing a plurality of batch executions. The method comprises selecting a first level element in a first level window; and displaying in a second level window all second level elements comprised by the selected first level element, the second level window being displayed within the first level window directly beneath the selected first level element without obscuring any other first level element in the first level window. The apparatus comprises a window display module configured for displaying at least one second level window within a first level window such that upon selection of a first level element in the first level window, a corresponding second level window is displayed within the first level window directly beneath its corresponding first level element without obscuring any other first level element in the first level window, each second level window displaying all second level elements comprised by its corresponding first level element.

### TECHNICAL FIELD

The present invention relates to a method and apparatus for displaying batch execution data of an industrial plant. It particularly relates to displaying batch execution data obtained during batch procedural control.

### BACKGROUND

As defined in ANSI/ISA-88.01-1995, Batch Control, Part 1: Models and Terminology, a batch process is “a process that leads to the production of finite quantities of material by subjecting quantities of input materials to an ordered set of processing activities over a finite period of time using one or more pieces of equipment.” In batch manufacturing plants, each ordered set of processing activities is typically referred to as a batch execution. In most batch processes, no two batch executions are exactly alike. Each batch execution will have a set of unique characteristics include production quality, cost, and speed.

In procedural control for batch processes, as also defined in “ANSI/ISA-88.01-1995, Batch Control, Part 1: Models and Terminology,” there are typically four levels in a hierarchy 800 of levels of procedural elements 810, 820, 830, 840, as shown in FIG. 8. Level elements in the four levels of procedural control are commonly referred to as “Procedures” 810, “Unit Procedures” 820, “Operations” 830 and “Phases” 840 respectively, as further defined in “ANSI/ISA-88.01-1995, Batch Control, Part 1: Models and Terminology.” Accordingly, a first level of batch processes comprises at least one first level element 810 or Procedure 810. Each first level element 810 may comprise at least one second level element 820 or Unit Procedure 820. Each second level element 820 may comprise at least one third level element 830 or Operation 830. Finally, each third level element 830 may comprise at least one fourth level element 840 or Phase 840.

In a batch manufacturing plant, a number of batch executions are usually monitored at once. Some of the batch executions may be completed while others are uncompleted or reserved pending performance. Each of the batch executions is typically a first level element or procedure 810 under procedural control as described above. All the batch executions or first level elements 810 are normally displayed as a list of first level elements 810 in a first window on a display screen. If a user wishes to check on the unit procedures or second level elements 820 for a particular batch execution 810, the user clicks on that particular batch execution 810. This will open a second window on top of the first window, showing all the unit procedures 820 for that batch execution 810. To check on a few batch executions 810 at once, a corresponding number of new windows need to be opened on the screen. To go further down the levels to check on operations 830 and phases 840 for a number of batch executions 810, even more new windows need to be opened on top of each other on the same screen. The screen is quickly cluttered, earlier-opened windows become obscured, and it becomes confusing for users to know which window is showing which level element 820, 830, 840 for which batch execution 810.

Furthermore, it is common in batch manufacturing plants for trend data to be collected during performance of each batch execution so that a trend data set is collected from each completed batch execution. In this way, production characteristics of each completed batch execution of the industrial plant may be recorded for future use.

Users of a batch management function in a control system of a batch manufacturing plant often want to remember specific completed batch executions that had particularly good characteristics. This is important as the users can then try to replicate those specific completed batch executions when performing subsequent batch executions in order to achieve similar good characteristics. Currently, particularly good completed batch executions are recorded by manually writing down their batch execution reference numbers in a log book or on a white board in a control room. Remarks are frequently written down beside each reference number to describe the specific characteristics that made that particular batch execution worth noting. Besides good batch executions, users may also record poorly completed batch executions to serve as negative examples. Looking for a specific recorded completed batch execution is therefore a tedious process as users need to pore over all the recorded batch executions in order to find a specific one.

An uncompleted batch execution may be a batch execution that is reserved and pending performance, or may be a batch execution that is being performed but has not yet been completed. When an uncompleted batch execution is being performed, for a specific completed batch execution to serve as a reference for the uncompleted batch execution, trend data that has been collected from the completed batch execution should be shown as a reference trend together with current trend data of the uncompleted batch execution. In this way, a user can see how well the uncompleted batch execution is matching the completed batch execution or how far any deviations may be.

Currently, to display a reference trend while monitoring an uncompleted batch execution, a user opens a window in the batch management function to look for a specific completed batch execution reference number among a plurality of stored completed batch execution reference numbers. The user knows the specific reference number that is being sought by having previously looked it up in the log book or white board containing the list of manually recorded completed batch execution reference numbers. When the specific reference number is found, the user selects it and the trend data set corresponding to this specific completed batch execution is then displayed as a reference trend together with the display of the current trend data.

### SUMMARY

According to a first exemplary aspect, there is provided a method of displaying batch execution data of an industrial plant configured for performing a plurality of batch executions, each batch execution comprising a hierarchy of levels of elements, each level comprising at least one level element. The method comprises selecting a first level element in a first level window; and displaying in a second level window second level elements comprised by the selected first level element, the second level window being displayed within the first level window directly beneath the selected first level element without obscuring any other first level element in the first level window.

The method may further comprise selecting another first level element displayed in the first level window; and displaying in another second level window second level elements comprised by the another first level element, the another second level window being displayed within the first level window directly beneath the another first level element without obscuring any other first level element in the first level window.

The method may further comprise selecting a second level element in the second level window and displaying in a third level window third level elements comprised by the selected second level element, the third level window being displayed within the second level window directly beneath the selected second level element without obscuring any other second level element in the second level window.

The method may further comprise selecting another second level element in the second level window; and displaying in another third level window third level elements comprised by the another second level element, the another third level window being displayed within the second level window directly beneath the another second level element without obscuring any other second level element in the second level window.

The method may further comprise displaying the selected first level element in a topmost row of first level elements in the first level window when displaying the second level window.

The method may further comprise displaying a particular level element as a marked level element, the marked level element being a procedural element at which the batch execution is currently transitioning.

The method may further comprise flagging at least one completed batch execution among a plurality of completed batch executions. The flagging may comprise selecting a flag from a group of flags, each of the flags denoting a distinct batch execution characteristic.

The method may further comprise associating a reference trend with an uncompleted batch execution, the reference trend being a trend data set collected from a completed batch execution; and selectably displaying the reference trend together with displaying the current trend data of the uncompleted batch execution.

Associating the reference trend with the uncompleted batch execution may comprise selecting a particular flagged completed batch execution. The method may further comprise displaying a plurality of flagged completed batch executions for selection of the particular flagged completed batch execution therefrom.

The method may further comprise selecting a second trend data set as a second reference trend and displaying the second reference trend together with displaying the current trend data.

According to a second exemplary aspect, there is provided an apparatus for displaying batch execution data of an industrial plant configured for performing a plurality of batch executions, each batch execution comprising a hierarchy of levels of elements, each level comprising at least one level element. The apparatus comprises a window display module configured for displaying at least one second level window within a first level window such that upon selection of a first level element in the first level window, a corresponding second level window is displayed within the first level window directly beneath its corresponding first level element without obscuring any other first level element in the first level window, each second level window displaying second level elements comprised by its corresponding first level element.

The window display module may be further configured to display the selected first level element in a topmost row of first level elements in the first level window when the second level window is displayed.

The window display module may be further configured for displaying at least one third level window within a second level window, such that upon selection of second level element in the second level window, a corresponding third level window is displayed within the second level window directly beneath its corresponding second level element without obscuring any other second level element in the second level window, each third level window displaying third level elements comprised by its corresponding second level element

The window display module may further be configured to display a particular level element as a marked level element, the marked level element being a procedural element at which the batch execution is currently transitioning.

The apparatus may further comprise a flag module configured for flagging at least one completed batch execution among a plurality of completed batch executions by selecting a flag from a group of flags, each of the flags denoting a distinct batch execution characteristic.

The apparatus may further comprise an association module configured for associating a reference trend with an uncompleted batch execution, the reference trend being a trend data set collected from a completed batch execution; and a trend display module configured for displaying current trend data of the uncompleted batch execution and for selectably displaying the reference trend together with the current trend data.

The association module may be further configured for displaying a plurality of flagged completed batch executions for selection of a particular flagged completed batch execution therefrom for providing the reference trend.

The trend display module may be further configured for displaying a second reference trend together with the current trend data, the second reference trend being selected from a plurality of collected trend data sets.

For both aspects, the second level window may comprise a plurality of rows configured for single-row scrolling display using a scroll bar provided for the first level window. The second level window may be configured to display a predetermined maximum number of rows of second level elements at a time if the first level window is of limited size. The third level window may comprise a plurality of rows configured for single-row scrolling display using a scroll bar provided for the first level window. The third level window may be configured to display a predetermined maximum number of rows of third level elements at a time if the first level window is of limited size.

### BRIEF DESCRIPTION OF THE DRAWINGS

In order that the present invention may be fully understood and readily put into practical effect, an embodiment of the invention will now be described by way of non-limitative example, the description being with reference to the accompanying illustrative drawings, in which:

FIG. 1 is an architecture diagram of an exemplary apparatus for displaying batch execution data of an industrial plant;

FIG. 2 is an exemplary screen capture of a display of a reference trend superimposed on current trend data;

FIG. 3 is a flowchart of an exemplary method for displaying batch execution data of an industrial plant;

FIG. 4 is an exemplary screen shot of flagged batch executions;

FIG. 5 is an exemplary screens shot of flagging a batch execution;

FIG. 6 is an exemplary screen shot of selecting a flagged completed batch execution for association of its collected trend data set as a reference trend with an uncompleted batch execution;

FIG. 7 is an exemplary screen shot of selecting a flagged completed batch execution for calling up its collected trend data set to be displayed as a second reference trend together with current trend data;

FIG. 8 is a procedural control model;

FIG. 9 is a flowchart of another exemplary method for displaying batch execution data of an industrial plant;

FIG. 10 is an architecture diagram of another exemplary apparatus for displaying batch execution data of an industrial plant;

FIG. 11 is an exemplary screen shot of displaying a second level window within a first level window;

FIG. 12 is an exemplary screen shot of displaying a third level window within the second level window of FIG. 11;

FIG. 13 is an exemplary screen shot of displaying a fourth level window within the third level window of FIG. 12;

FIG. 14 is an exemplary screen shot of displaying a further second level window within the first level window of FIG. 11;

FIG. 15 is an exemplary screen shot of displaying a marked level element;

FIG. 16 is an exemplary screen shot of level windows comprising a plurality of single-row scrollable rows and a level window displaying a maximum of five rows of level elements;

FIG. 17 is an exemplary screen shot of selecting a first level element for expansion in a first level window; and

FIG. 18 is an exemplary screen shot of moving the selected first level element to a top row of level elements in the first level window when displaying a second level window.

### DETAILED DESCRIPTION OF THE PREFERRED EMBODIMENTS

With reference to FIGS. 1 to 15, exemplary embodiments of a method and apparatus for displaying batch execution data of an industrial plant will now be described. Throughout this specification, the word “a” is not limited to mean “only one” and may mean “one or more”.

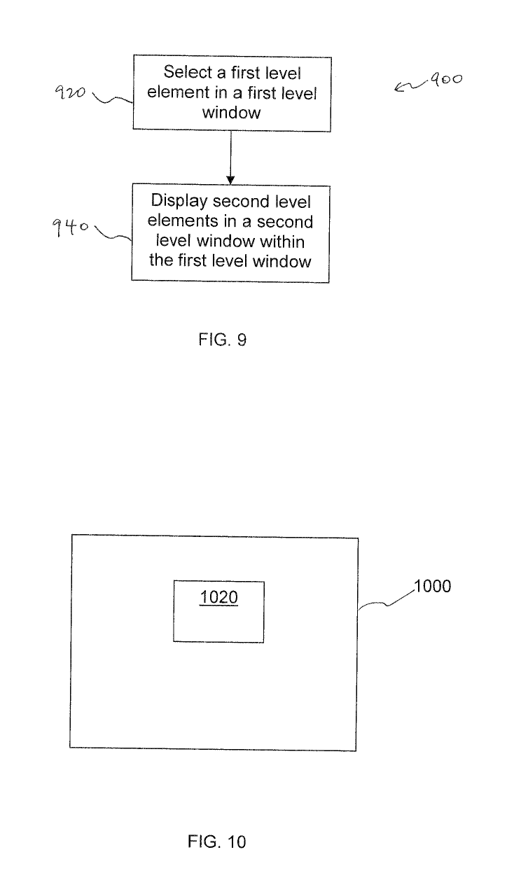

In a batch manufacturing plant, it is often desirable to monitor a number of batch executions 161 at once, as shown in the exemplary screen shot of FIG. 4. Each of the batch executions 161 shown in FIG. 4 is typically a first level element 810 or procedure 810 under procedural control as described with reference to FIG. 8 above. When checking subsequent level elements 820, 830, 840 for batch executions 810, in order to avoid the clutter and confusion of opening more and more new windows on top of each other as practiced in the prior art, a method 900 and apparatus 1000 as shown in FIGS. 9 and 10 are provided.

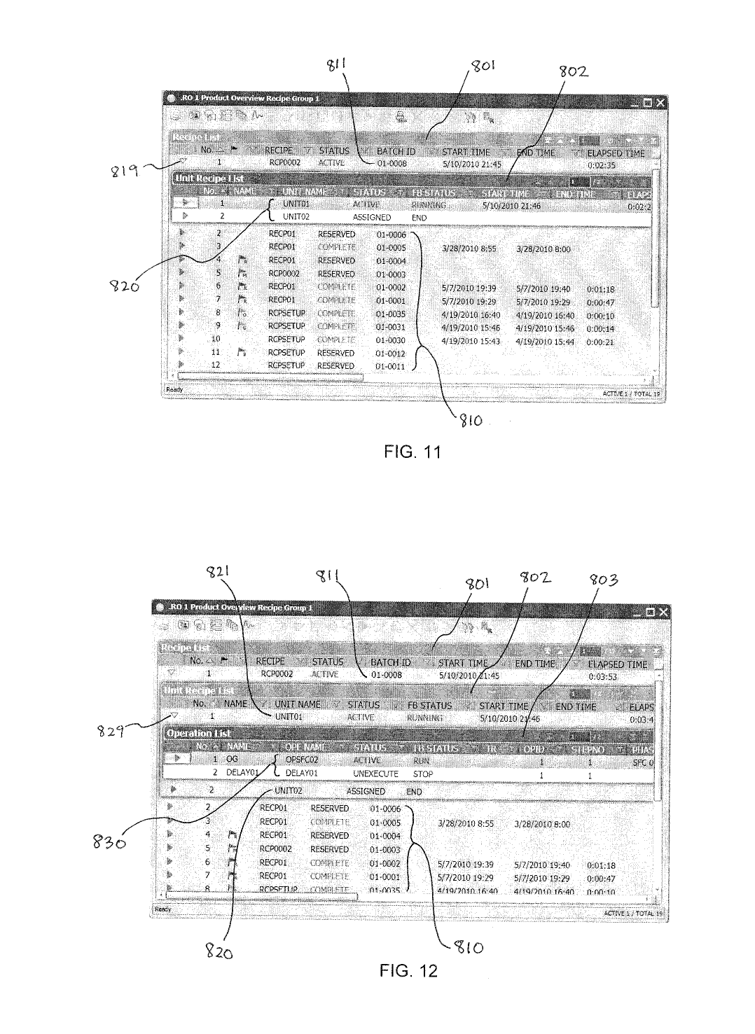

In the method 900, to check on a particular batch execution or first level element 811 that is shown in a first level window 801, as depicted in the exemplary screen shot of FIG. 11, a user selects the first level element 811 in the first level window 801, 920 in order to expand it. This may be done by clicking on a special icon 819 for the selected first level element 811, that is also provided for each first level element 810, such as a triangle 819 as shown. Before selection, the triangle 819 may point to the right. After selection, the triangle 819 may point down. A window display module 1020 of the apparatus 1000 is configured such that selecting the first level element 811, 920 leads to a subsequent or second level window 802 being displayed or opened within the first level window 801, 940 directly beneath the selected first level element 811, and without obscuring any other first level element 810 in the first level window 801, as shown in FIG. 11. This means that all the other first level elements 810 that were originally displayed under the selected first level element 811 in the first level window 801 are moved down in the first level window 801 to become displayed under the second level window 802, while remaining in the first level window 801. In this way, it is clear to a user that the second level elements 820 displayed in the second level window 802 are comprised by or “belong to” the selected first level element 811 and not any other first level element 810.

Similarly, the method 900 and apparatus 1000 allow a user to select a second level element 821 in the second level window 802 for expansion by clicking on its provided icon 829. Upon doing so, third level elements 830 comprised by the selected second level element 821 are displayed in a subsequent or third level window 803. The third level window 803 is displayed within the second level window 802, directly beneath the selected second level element 821, as shown in the exemplary screen shot in FIG. 12. In this way, it is clear to the user that the third level elements 830 belong to the selected second level element 821, which in turn belongs to the selected first level element 811.

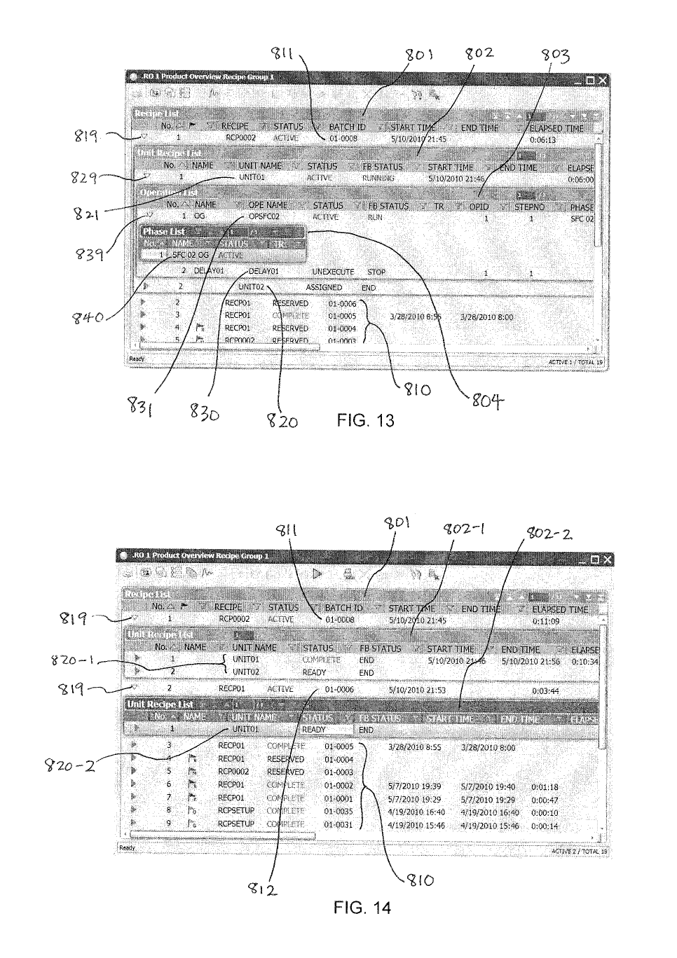

Fourth level elements 840 may similarly be displayed in a subsequent fourth level window 804, as shown in the exemplary screen shot in FIG. 13, when a third level element 831 in the third level window 803 is selected for expansion by clicking on its icon 839 that is provided for each third level element 830. Similarly, the fourth level window 804 is displayed within the third level window 803, directly beneath the selected third level element 831.

The method 900 and apparatus 1000 thus permit each subsequently opened level window 802, 803 or 804 to be displayed within its preceding level window, without obscuring other level elements in the preceding level window. This results in a progressive nest of windows being displayed whenever a user wishes to view each batch execution 811 in more detail by expanding subsequent level elements 811, 821, 831, for example as shown by the nest of level windows 801, 802, 803, 804 displayed in FIG. 13. By displaying each newly opened window within a previously opened one, clutter and confusion are avoided since it is clear to the user that each nest of windows is for only a particular batch execution 811.

The method 900 and apparatus 1000 are also configured to allow more than one level element for a same level to be displayed at any one time. For example, as shown in the exemplary screen shot of FIG. 14, two first level elements 811, 812 have been selected in the first level window 801. Accordingly, two corresponding second level windows 802-1, 802-2 are opened. Both second level windows 802-1, 802-2 are displayed within the first level window 801, each one 802-1, 802-2 directly beneath its respective selected first level element 811, 812. Similarly, multiple second, third, and fourth level elements 820, 830, 840 may be selected to open multiple second, third, and fourth level windows 802, 803, 804 respectively. Even so, the nesting of windows using the method 900 and apparatus 1000 allows the user to continue having an uncluttered and clear view of all the various level elements that are on display.

To facilitate ease of viewing for users, a scroll bar 880 may be provided for the first level window 801 in order to view all contents that are further down within the first level window 801, as shown in FIG. 16. It will be appreciated that contents within the first level window may include one or more subsequent level windows 802, 803, 804 if they have already been opened. Each of the level windows 801, 802, 803, 804 comprises a number of rows including a header row 861, a menu row 862 and one or more rows 860 of level elements. The level windows 801, 802, 803, 804 are configured such that single-row scrolling is permitted by use of the scroll bar 880, for example, when making single clicks of the single row scroll buttons 887-1, 887-2 on either end of the scroll bar 880 or dragging the scroll bar thumb 888. The level windows 801, 802, 803, 804 are therefore not configured as conventional single blocks of row detail where each block is treated as a single row such that the entire block of row detail is skipped when only clicking once on the down-scroll button 887-2. By configuring the level windows 801, 802, 803, 804 to allow single-row scrolling where each row 861, 862, 860 is recognized and treated as a discrete row, users are provided with a user-customizable display to show a selected range of specific rows 861, 862, 860 within the first level window 801.

Within subsequent level windows 802, 803, 804, preferably no scroll bar 880 is provided because this would undesirably reduce the display area of each subsequent level window 802, 803, 804 opened. Instead, scroll buttons 881 to 886 are preferably provided to still allow scrolling within each subsequent level window 802, 803, 804. Preferably, the scroll buttons 881 to 886 are configured to “jump to top” 881, “jump to bottom” 886, move a page up 882, move a page down 885, move one row up 883 and move one row down 884. By providing the scroll bar 880 only for the first level window 801 and scroll buttons 881 to 886 for the subsequent level windows 802, 803, 804, a user-friendly and intuitive interface that also maximizes display area is provided to users.

To further simplify the display of batch execution data, each subsequent level window 802, 803, or 804 that is currently active (for example the third level window 803 in FIG. 16) is preferably configured to display a predetermined maximum number of rows 860 of level elements at a time, if there are more than the predetermined maximum number of level elements 820, 830 or 840 respectively in that subsequent level window 802, 803, or 804, and available window space in the first level window 801 is limited. Remaining rows 860 of level elements other than the predetermined maximum number on display may be viewed by using appropriate ones of the provided scroll buttons 881 to 886. Such a configuration is especially useful where a limited display area is available, so that data presented in each subsequent level window 802, 803, or 804 is contained manageably, and a simpler visual effect is achieved to improve clarity for users. In the exemplary embodiment shown in FIG. 16, the predetermined maximum number of rows 860 to be displayed is five. Preferably, this number can be customized by the user.

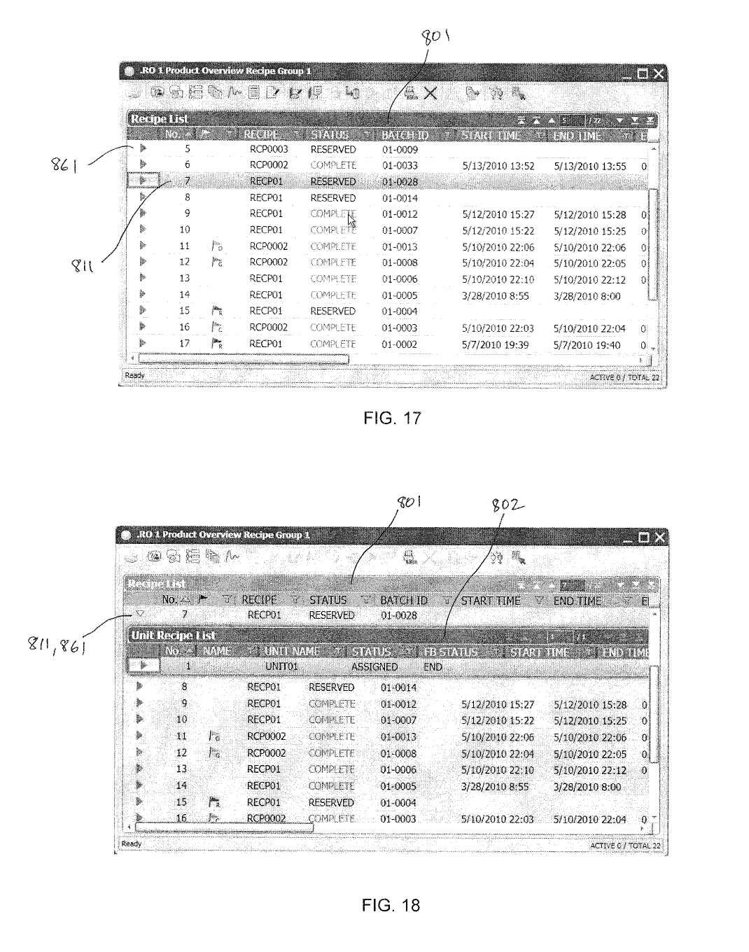

To further improve clarity for users, any currently selected first level element 811 in a first level window, as shown in FIG. 17, is moved to a top row 861 of first level elements 810 when expanded to display its corresponding second level window 802. The user thus always knows that the batch execution 811 in the top row 861 is always the one to which subsequent opened level windows 802, 803 or 804 belong, and is currently in active view. Moving a currently active expanded batch execution 811 to the top row 861 also creates more space below for displaying further expanded subsequent level windows 802, 803, 804 to minimize the need for scrolling up and down within windows in order to see areas of interest.

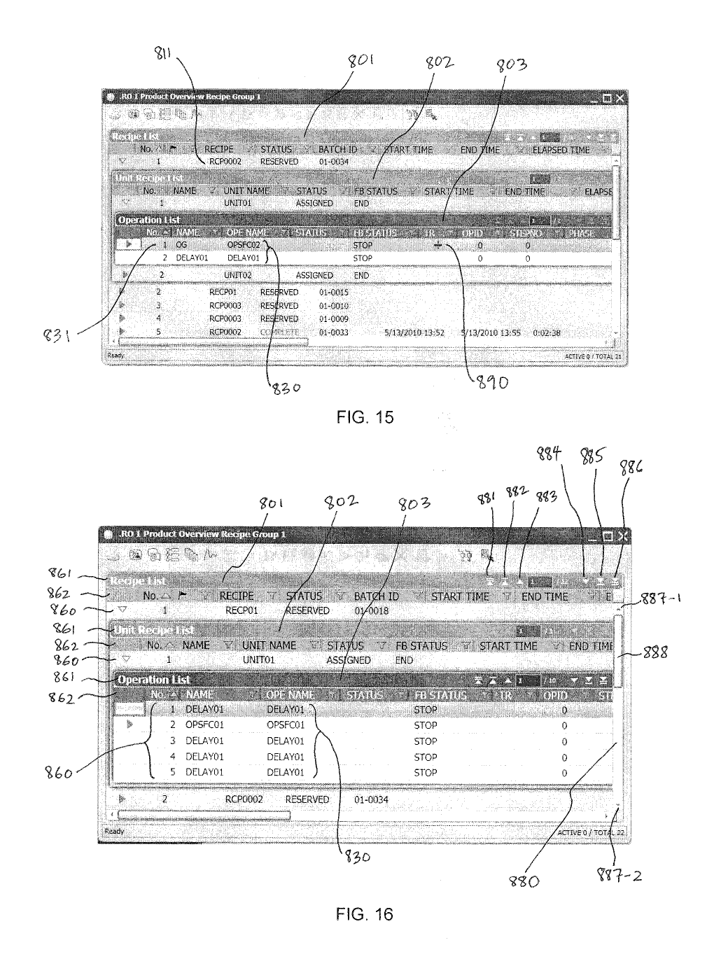

In addition to displaying the level windows in a progressively nested manner, the method 900 and apparatus 1000 may further be configured to display a particular level element as a marked level element. The marked level element is a procedural element at which the batch execution is currently transitioning. For example, as shown in the exemplary screen shot of FIG. 15, a particular third level element 830 has been displayed as a marked element 831 by displaying a mark 890 in the shape of a “+” for that element 831. This allows users to know that the batch execution 811 is currently transitioning at the marked third level element 831. Transitioning may mean that the batch execution 811 is processing at that marked level element 831, or that it has halted at that marked element 831. In either case, displaying the transition mark 890 at a particular level element informs users that the batch execution is currently processing or halted at the marked level element 831 and not anywhere else.

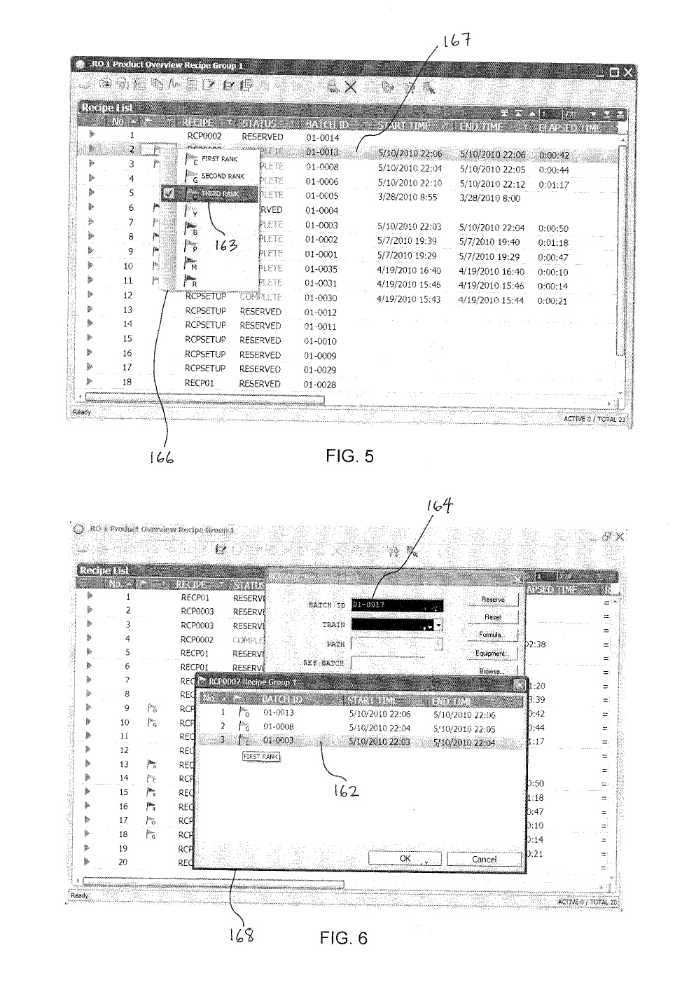

As shown in FIG. 1, the apparatus 1000 may further comprise a flag module 160 configured for flagging at least one batch execution 165 among a plurality of batch executions 161, as shown in the exemplary screen shot of FIG. 4. As shown in the exemplary screen shot of FIG. 5, flagging a batch execution 167 may be by selecting a flag 163 for that batch execution 167 from a group of flags in a drop-down menu 166. Each flag in the group 166 is differentiated to denote a distinct batch execution characteristic. For example, a red flag may be used to denote a batch execution with first ranked production results while a yellow flag may be used to denote a third ranked production result. By using the flag module 160 to flag certain batch executions 165, users can therefore readily tell the batch execution characteristic of each flagged batch execution by the color of its flag.

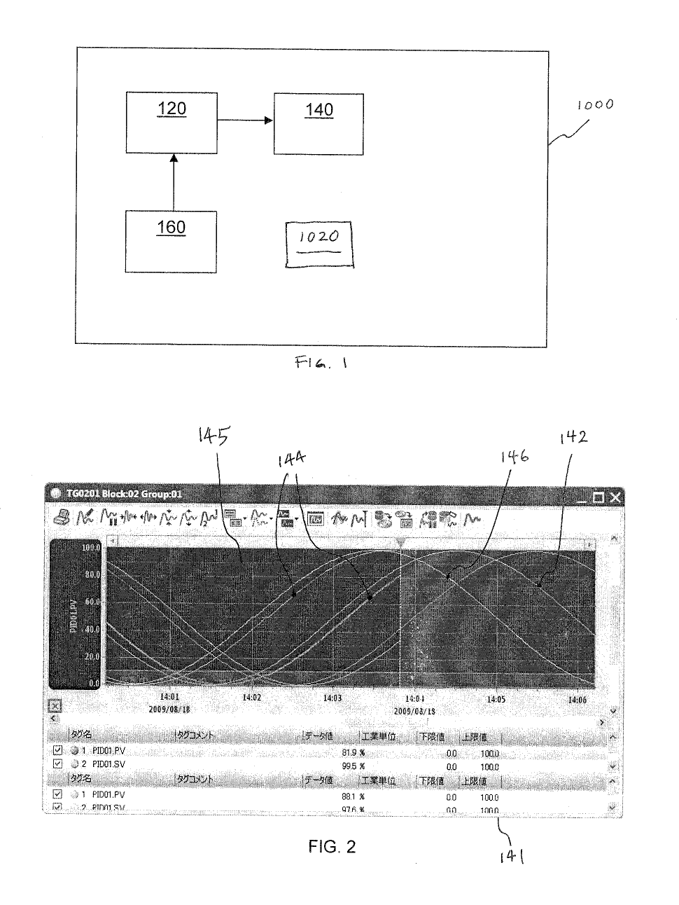

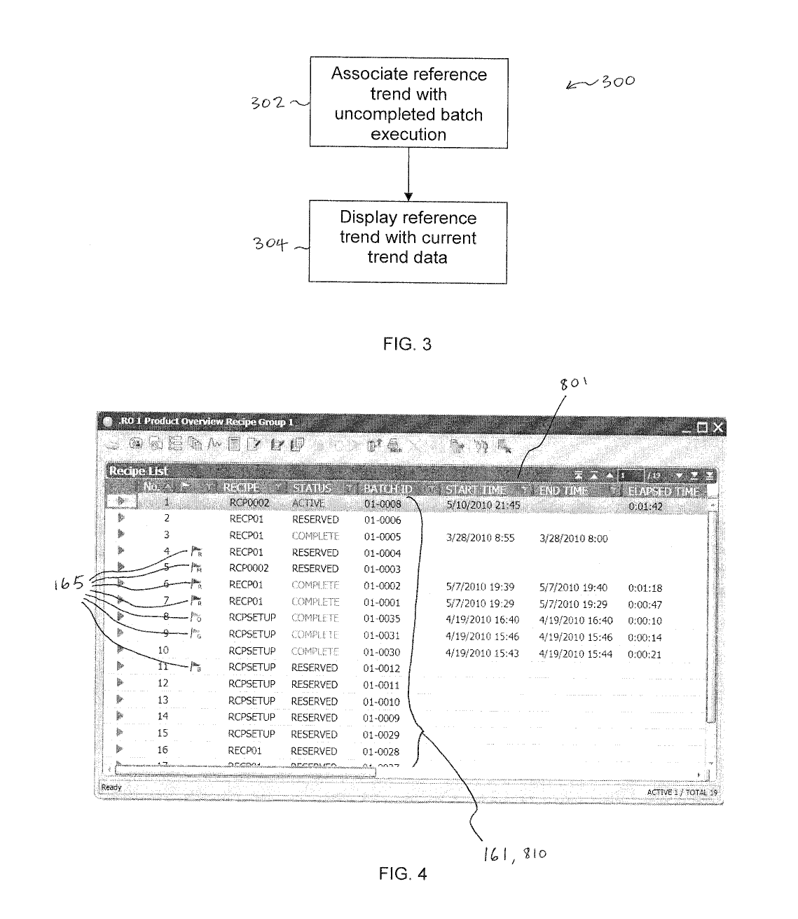

The apparatus 1000 may also comprise an association module 120 configured for associating a reference trend 142 with an uncompleted batch execution 302, in additional method steps 300 shown in FIG. 3. The reference trend 142 is associated for display together with current trend data 144 of the uncompleted batch execution 304 as shown in FIG. 2. A reference trend 142 is a trend data set that has been collected from a completed batch execution having certain characteristics. For example, a particular completed batch execution may have a desirable production quality that a user hopes to achieve for a subsequent uncompleted batch execution. Associating the reference trend 142 with the uncompleted batch execution links the reference trend 142 to the uncompleted batch execution so that when the uncompleted batch execution is being performed, the reference trend 142 may be readily accessed for comparison with current trend data 144 that is being collected from the uncompleted batch execution while it is being performed.

A trend display module 140 is provided to display the current trend data 144 so that a user may monitor how the uncompleted batch execution is performing. The trend display module 140 is also configured for selectably displaying the reference trend 142 together with displaying the current trend data 144. This may be done by superimposing the reference trend 142 on the current trend data 144, as shown in the exemplary screen shot 141 in FIG. 2. Because the reference trend 142 has already been associated with the uncompleted batch execution, the reference trend 142 may be readily displayed by a simple right-click of the mouse to call up the reference trend 142, and another right-click may remove the reference trend 142 from display. Alternatively, a dedicated on-screen button or icon may be provided for a user to click on in order to call up the reference trend 142 and display it together with the current trend data 144 in a same trend panel 145.

By displaying the reference trend 142 together with the current trend data 144, a user can attempt to match current trend data 144 to the reference trend 142 by adjusting appropriate production parameters of the uncompleted batch execution while it is being performed. In this way, the uncompleted batch execution that is being performed may achieve similar characteristics as the completed batch execution from which the reference trend 142 was obtained.

Where a flag module 160 is provided, a particular flagged completed batch execution 162 may be selected by a user for providing the reference trend 142 for association with an uncompleted batch execution 164. Accordingly, the association module 120 may be further configured to display a plurality of flagged completed batch executions 168 as shown in FIG. 6. In this way, when a user wants to associate a reference trend 142 with an uncompleted batch execution 164, the user may simply select a particular flagged completed batch execution 162 from the plurality of flagged completed batch executions 168. The trend data set collected from the selected flagged completed batch execution 162 will thus be associated with the uncompleted batch execution 164 as its reference trend 142. As mentioned above, once the reference trend 142 has been associated with the uncompleted batch execution 164, displaying the reference trend 142 becomes a simple matter of a right click or clicking a dedicated icon on the trend panel 145.

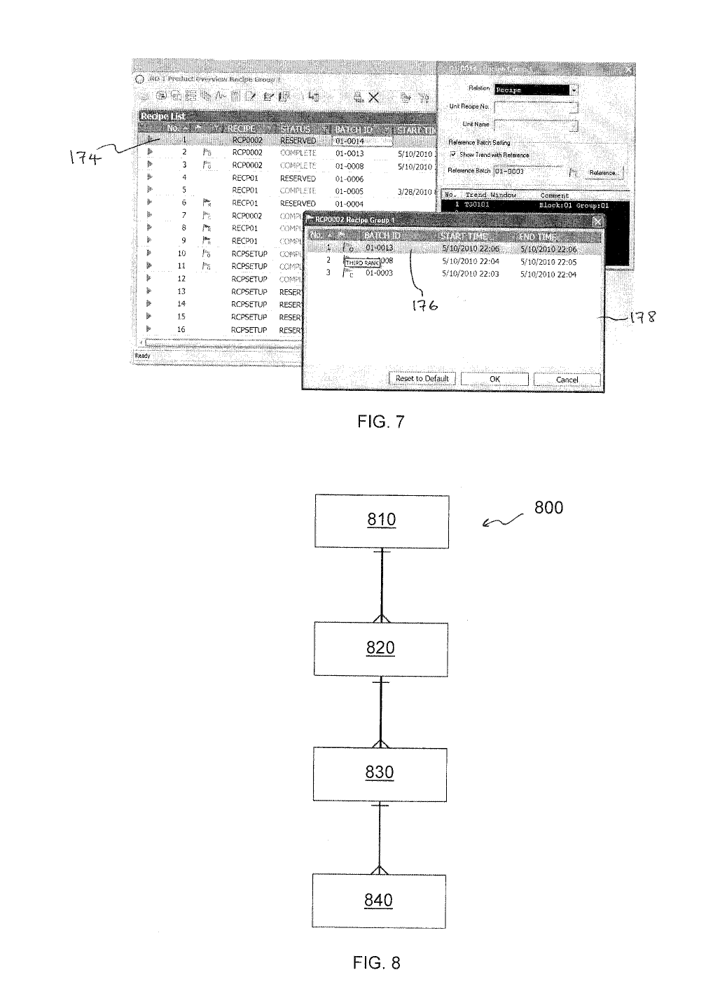

In addition to selectably displaying the reference trend 142 together with the current trend data 144, 304, the trend display module 140 may also be configured to display a second reference trend 146 together with the current trend data 144. Unlike the reference trend 142 which has already been associated with the uncompleted batch execution, the second reference trend 146 is a second trend data set collected from a second completed batch execution 176 which has not been associated with the uncompleted batch execution. This configuration of the trend display module 140 is to allow users to call up ad-hoc reference trends for comparison with the current trend data 144 if need be. To do so, as shown in FIG. 7, the second reference trend 146 is obtained from a second completed batch execution 176 that is manually selected from a plurality of collected trend data sets 178. Unlike the associated reference trend 142, a simple right click to display the second reference trend 146 is not available because the second reference trend 146 has not been associated with the uncompleted batch execution 174. By allowing users to call up an ad-hoc reference trend 146 for comparison with the current trend data 144 besides the associated reference trend 142, more improvement may be made to the batch process.

Whilst there has been described in the foregoing description preferred embodiments of the present invention, it will be understood by those skilled in the technology concerned that many variations or modifications in details of design or construction may be made without departing from the present invention.

1. A method of displaying batch execution data of an industrial plant configured for performing a plurality of batch executions, each batch execution comprising a hierarchy of levels of elements, each level comprising at least one level element, the method comprising:
selecting a first level element in a first level window; and
displaying in a second level window second level elements comprised by the selected first level element, the second level window being displayed within the first level window directly beneath the selected first level element without obscuring any other first level element in the first level window.

2. The method of claim 1, further comprising selecting another first level element displayed in the first level window; and displaying in another second level window second level elements comprised by the another first level element, the another second level window being displayed within the first level window directly beneath the another first level element without obscuring any other first level element in the first level window.

3. The method of claim 1, wherein the second level window comprises a plurality of rows configured for single-row scrolling display using a scroll bar provided for the first level window.

4. The method of claim 1, wherein the second level window is configured to display a predetermined maximum number of rows of second level elements at a time if the first level window is of limited size.

5. The method of claim 1, further comprising selecting a second level element in the second level window and displaying in a third level window third level elements comprised by the selected second level element, the third level window being displayed within the second level window directly beneath the selected second level element without obscuring any other second level element in the second level window.

6. The method of claim 5, further comprising selecting another second level element in the second level window; and displaying in another third level window third level elements comprised by the another second level element, the another third level window being displayed within the second level window directly beneath the another second level element without obscuring any other second level element in the second level window.

7. The method of claim 5, wherein the third level window comprises a plurality of rows configured for single-row scrolling display using a scroll bar provided for the first level window.

8. The method of claim 5, wherein the third level window is configured to display a predetermined maximum number of rows of third level elements at a time if the first level window is of limited size.

9. The method of claim 1, further comprising displaying the selected first level element in a topmost row of first level elements in the first level window when displaying the second level window.

10. The method of claim 1, further comprising displaying a particular level element as a marked level element, the marked level element being a procedural element at which the batch execution is currently transitioning.

11. The method of claim 1, further comprising flagging at least one completed batch execution among a plurality of completed batch executions.

12. The method of claim 11, wherein the flagging comprises selecting a flag from a group of flags, each of the flags denoting a distinct batch execution characteristic.

13. The method of claim 11, further comprising associating a reference trend with an uncompleted batch execution, the reference trend being a trend data set collected from a completed batch execution; and selectably displaying the reference trend together with displaying the current trend data of the uncompleted batch execution.

14. The method of claim 13, wherein associating the reference trend with the uncompleted batch execution comprises selecting a particular flagged completed batch execution.

15. The method of claim 14, further comprising displaying a plurality of flagged completed batch executions for selection of the particular flagged completed batch execution therefrom.

16. The method of claim 13, further comprising selecting a second trend data set as a second reference trend and displaying the second reference trend together with displaying the current trend data.

17. An apparatus for displaying batch execution data of an industrial plant configured for performing a plurality of batch executions, each batch execution comprising a hierarchy of levels of elements, each level comprising at least one level element, the apparatus comprising:
a window display module configured for displaying at least one second level window within a first level window such that upon selection of a first level element in the first level window, a corresponding second level window is displayed within the first level window directly beneath its corresponding first level element without obscuring any other first level element in the first level window, each second level window displaying second level elements comprised by its corresponding first level element.

18. The apparatus of claim 17, wherein the second level window comprises a plurality of rows configured for single-row scrolling display using a scroll bar provided for the first level window.

19. The apparatus of claim 17, wherein the second level window is configured to display a predetermined maximum number of rows of second level elements at a time if the first level window is of limited size.

20. The apparatus of claim 17, wherein the window display module is further configured to display the selected first level element in a topmost row of first level elements in the first level window when the second level window is displayed.

21. The apparatus of claim 17, wherein the window display module is further configured for displaying at least one third level window within a second level window, such that upon selection of second level element in the second level window, a corresponding third level window is displayed within the second level window directly beneath its corresponding second level element without obscuring any other second level element in the second level window, each third level window displaying third level elements comprised by its corresponding second level element

22. The apparatus of claim 21, wherein the third level window comprises a plurality of rows configured for single-row scrolling display using a scroll bar provided for the first level window.

23. The apparatus of claim 21, wherein the third level window is configured to display a predetermined maximum number of rows of third level elements at a time if the first level window is of limited size.

24. The apparatus of claim 17, wherein the window display module is further configured to display a particular level element as a marked level element, the marked level element being a procedural element at which the batch execution is currently transitioning.

25. The apparatus of claim 17, further comprising a flag module configured for flagging at least one completed batch execution among a plurality of completed batch executions by selecting a flag from a group of flags, each of the flags denoting a distinct batch execution characteristic.

26. The apparatus of claim 25, further comprising an association module configured for associating a reference trend with an uncompleted batch execution, the reference trend being a trend data set collected from a completed batch execution; and a trend display module configured for displaying current trend data of the uncompleted batch execution and for selectably displaying the reference trend together with the current trend data.

27. The apparatus of claim 26, wherein the association module is further configured for displaying a plurality of flagged completed batch executions for selection of a particular flagged completed batch execution therefrom for providing the reference trend.

28. The apparatus of claim 26, wherein the trend display module is further configured for displaying a second reference trend together with the current trend data, the second reference trend being selected from a plurality of collected trend data sets.
